(19) United States
(12) Patent Application Publication
(10) Pub. No.: US 2020/0041304 A1
(43) Pub. Date: Feb. 6, 2020

(54) HIGH RESOLUTION VIRTUAL WHEEL SPEED SENSOR

(71) Applicant: GM Global Technology Operations LLC, Detroit, MI (US)

(72) Inventors: Carlos E. Arreaza, Oakville (CA); Amin Abdossalami, Toronto (CA); Norman J. Weigert, Whitby (CA); Daniel S. Maitlen, Farmington Hills, MI (US); David M. Sidlosky, Beverly Hills, MI (US)

(21) Appl. No.: 16/050,189

(22) Filed: Jul. 31, 2018

(51) Int. Cl. G01C 22/00; G06T 7/246

(52) U.S. Cl. CPC G01C 22/00; G01D 5/145; G06T 7/246

(57) ABSTRACT

A method for producing high resolution virtual wheel speed sensor data includes simultaneously collecting wheel speed sensor (WSS) data from multiple wheel speed sensors each sensing rotation of one of multiple wheels of an automobile vehicle. A camera image is generated of a vehicle environment from at least one camera mounted in the automobile vehicle. An optical flow program is applied to discretize the camera image in pixels. Multiple distance intervals are overlayed onto the discretized camera image each representing a vehicle distance traveled defining a resolution of each of the multiple wheel speed sensors. A probability distribution function is created predicting a distance traveled for a next WSS output.

### INTRODUCTION

The present disclosure relates to automobile vehicle steering wheel speed sensing systems for prediction of vehicle motion.

Known automobile vehicle wheel speed sensing (WSS) systems commonly include a slotted wheel that co-rotates with each of the vehicle wheels that includes multiple equally spaced teeth about a perimeter of the slotted wheel. A sensor detects rotary motion of the slotted wheel and generates a square wave signal that is used to measure wheel rotation angle and rotation speed. Known WSS systems have a resolution of about 2.6 cm of vehicle travel for a system using a slotted wheel having 96 counts per revolution, or about 5.2 cm for a system using a slotted wheel having 48 counts per revolution, for a standard wheel size of 16 inch radius. Different resolutions are calculated for different wheel sizes. Resolution of the signal is a function of a quantity of teeth of the slotted wheel and the capability of the sensor to capture accurate images of the teeth as the slotted wheel rotates. Better resolution of vehicle progression is desired for several applications including for autonomous and active safety systems, for parking maneuvers, and for trailering. Resolution solutions that estimate and predict vehicle motion at slow speeds are also currently not available or are limited by the existing slotted wheel sensor systems.

Thus, while current automobile vehicle WSS systems achieve their intended purpose, there is a need for a new and improved system and method for incorporating vehicle kinematics to calculate higher resolution vehicle displacement and motion and to create improved path planning algorithms. Higher resolution predictions are also required for vehicle displacement at low speeds.

### SUMMARY

According to several aspects, a method for producing high resolution virtual wheel speed sensor data includes: collecting wheel speed sensor (WSS) data from multiple wheels of an automobile vehicle; generating a camera image from at least one camera mounted to the automobile vehicle; overlaying multiple distance intervals onto the camera image each representing a vehicle distance travelled obtained from the WSS data; and applying an optical flow program to discretize the camera image in pixels to increase a resolution of each vehicle distance traveled.

In another aspect of the present disclosure, the method further includes determining if a vehicle steering angle is greater than a predetermined threshold; and normalizing the WSS data if vehicle steering angle identifies the vehicle is turning.

In another aspect of the present disclosure, the method further includes adding data from multiple camera feeds of the vehicle plus a steering angle, one or more tire pressures, global positioning system (GPS) data, and vehicle kinematics.

In another aspect of the present disclosure, the method further includes incorporating an effective tire radius by adding a tire pressure and tire slip to account for different wheel rotational speeds occurring due to tire size and tire wear.

In another aspect of the present disclosure, the method further includes identifying wheel rotational speeds from the WSS data; and normalizing the wheel rotational speeds by scaling up or down time depending on steering wheel angle.

In another aspect of the present disclosure, the method further includes during a learning phase accessing data including a steering angle and each of a tire pressure and a tire slip for each of the multiple wheels; and creating a probability distribution function defining a relationship between first tick distribution values of one wheel speed sensor versus second tick distribution values from the one wheel speed sensor.

In another aspect of the present disclosure, the method further includes applying an Ackerman steering model to include wheel speed differences occurring during steering or vehicle turns at vehicle speeds below a predetermined threshold.

In another aspect of the present disclosure, the method further includes inputting each of: a value of an effective tire radius; and a value of tire slip.

In another aspect of the present disclosure, the effective tire radius defines a tire radius for each of a front left tire, a front right tire, a rear left tire and a rear right tire.

In another aspect of the present disclosure, the method further includes: enabling an optical flow program including: in a first optical flow feature detecting corners and features of a camera image; in a second optical feature running an optical flow algorithm; in a third optical feature, obtaining output vectors; and in a fourth optical feature averaging the output vectors and deleting outliers to obtain a highest statistically significant optical vector that defines a vehicle distance traveled in pixels.

According to several aspects, a method for producing high resolution virtual wheel speed sensor data including: simultaneously collecting wheel speed sensor (WSS) data from multiple wheel speed sensors each sensing rotation of one of multiple wheels of an automobile vehicle; generating a camera image of a vehicle environment from at least one camera mounted in the automobile vehicle; overlaying multiple distance intervals onto the camera image each representing a vehicle distance traveled generated from the WSS data; and creating a probability distribution function predicting a distance traveled for a next WSS output.

In another aspect of the present disclosure, the probability distribution function defines a relationship between first tick distribution values of individual ones of the wheel speed sensors versus second tick distribution values from the same one of the wheel speed sensors.

In another aspect of the present disclosure, the method further includes applying an optical flow program to discretize the camera image in pixels.

In another aspect of the present disclosure, the method further includes applying a predetermined quantity of pixels per centimeter for each of the distance intervals such that the discretizing step enhances the resolution from centimeters to millimeters.

In another aspect of the present disclosure, the method further includes identifying wheel rotational speeds from the WSS data and normalizing the wheel rotational speeds by dividing each of the wheel rotational speeds by a same one of the wheel rotational speeds.

In another aspect of the present disclosure, the method further includes generating optical flow output vectors for the camera image; and discretizing the camera image to represent a physical distance traveled by the automobile vehicle.

In another aspect of the present disclosure, the method further includes generating the wheel speed sensor (WSS) data using slotted wheels co-rotating with each of the multiple wheels, with a sensor reading ticks as individual slots of the slotted wheels pass the sensor, the slotted wheels each having a quantity of slots defining a resolution for each of the multiple distance intervals.

According to several aspects, a method for producing high resolution virtual wheel speed sensor data includes simultaneously collecting wheel speed sensor (WSS) data from multiple wheel speed sensors each sensing rotation of one of multiple wheels of an automobile vehicle. A camera image is generated of a vehicle environment from at least one camera mounted in the automobile vehicle. Multiple distance intervals are overlayed onto the camera image each representing a vehicle distance traveled defining a resolution of each of the multiple wheel speed sensors. An optical flow program is applied to discretize the camera image in pixels including applying approximately 10 pixels per centimeter for each of the distance intervals. A probability distribution function is created predicting a distance traveled for a next WSS output.

In another aspect of the present disclosure, each wheel speed sensor determines rotation of a slotted wheel co-rotating with one of the four vehicle wheels, each slotted wheel including multiple equally spaced teeth positioned about a perimeter of the slotted wheel; and the applying step enhances the resolution from centimeters derived from a spacing of the teeth to millimeters.

In another aspect of the present disclosure, the method further includes: identifying wheel speeds from the WSS data; applying an Ackerman steering model with Ackerman error correction to include differences in the wheel speeds occurring during steering or vehicle turns at vehicle speeds below a predetermined threshold; generating optical flow output vectors for the camera image; and averaging the output vectors to obtain a highest statistically significant optical vector to further refine a value of the vehicle distance traveled.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic presentation of a method for producing high resolution virtual wheel speed sensor data according to an exemplary embodiment;

FIG. 2 is a graph providing an output from each of four wheel speed sensors plotted over time;

FIG. 3 is a plan view of a camera image overlayed with multiple distance intervals derived from wheel speed sensor data;

FIG. 4 is a plan view of area 4 of FIG. 3; and

FIG. 5 is a graph presenting multiple wheel distance pulse counts versus time for a vehicle traveling in a straight path;

FIG. 6 is a graph presenting multiple wheel distance pulse counts versus time for a vehicle that is turning;

FIG. 7 is a graph presenting tick frequencies over time of a signal tick distribution; and

FIG. 8 is a graph of a probability distribution function generated using the signal tick distribution of FIG. 7;

FIG. 9 is a diagrammatic presentation of the Ackerman Steering Model applied to account for wheel speed differences occurring during steering or vehicle turns; and

FIG. 10 is a flowchart identifying method steps used in applying an algorithm defining the method for producing high resolution virtual wheel speed sensor data of the present disclosure.

### DETAILED DESCRIPTION

The following description is merely exemplary in nature and is not intended to limit the present disclosure, application, or uses.

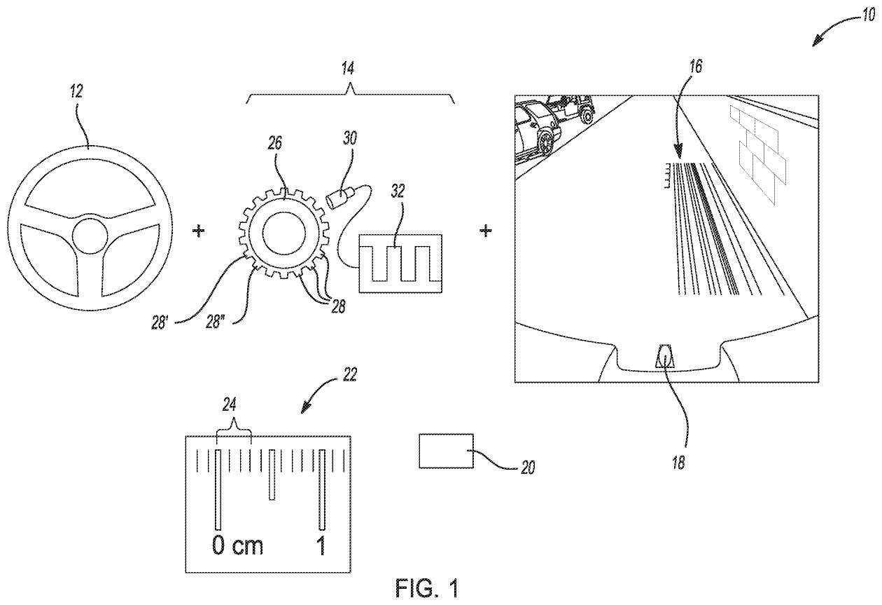

Referring to FIG. 1, a method for producing high resolution virtual wheel speed sensor data 10 receives a steering data input 12 which distinguishes if an automobile vehicle is travelling in a straight line or is turning, a wheel speed sensor (WSS) portion 14, and an optical flow data 16 from at least one vehicle mounted camera 18 such as a front-facing camera or a backup camera. System data is sent to a controller 20 such as an engine controller. The controller 20 includes and actuates an algorithm discussed in greater detail in reference to FIG. 9 which fuses the steering data input 12, the WSS data from all four wheels of the WSS portion 14, and the optical flow data 16 to calculate a high resolution vehicle displacement value 22. The vehicle displacement value 22 may for example have a resolution value 24 of approximately 3 mm, improved from the approximate 2.6 cm resolution currently available using only WSS data from a single vehicle wheel sensor for a standard sixteen inch radius wheel. The resolution “R” for any wheel size is calculated as follows:

R=(2×π×wheel radius)/quantity of slots per revolution

According to several aspects, the wheel speed sensor (WSS) portion 14 includes a slotted wheel 26 provided for each of the four vehicle wheels shown in reference to FIGS. 1 and 8. According to several aspects, each slotted wheel 26 may be approximately six inches in diameter and co-rotates with one of the four vehicle wheels. Other slotted wheel diameters are also applicable within the scope of the present disclosure. Each slotted wheel 26 includes multiple equally spaced teeth 28 positioned about a perimeter of the slotted wheel 26. A sensor 30 provided for each of the slotted wheels 26 identifies rotary motion by detecting movement of the teeth 28 past the sensor 30 as the slotted wheel 26 rotates. According to several aspects, the sensor 30 is a Hall Effect sensor, however, other sensor designs can also be used within the scope of the present disclosure. The output of each sensor 30 defines a wave signal 32 based on a passage of the teeth 28 over time that is used to measure wheel rotation angle and rotation speed. A resolution of a vehicle distance traveled is a function of a spacing between any two successive teeth of the slotted wheels. Based on an exemplary geometry of the slotted wheel 26 having 96 teeth, the resolution of a vehicle distance traveled of approximately 2.6 cm is provided based on a spacing between any two successive teeth such as between a first tooth 28′ and a second tooth 28″, as the slotted wheel 26 rotates. The resolution of other slotted wheels 26 having more or less than 96 teeth will vary according to the quantity of teeth as discussed above.

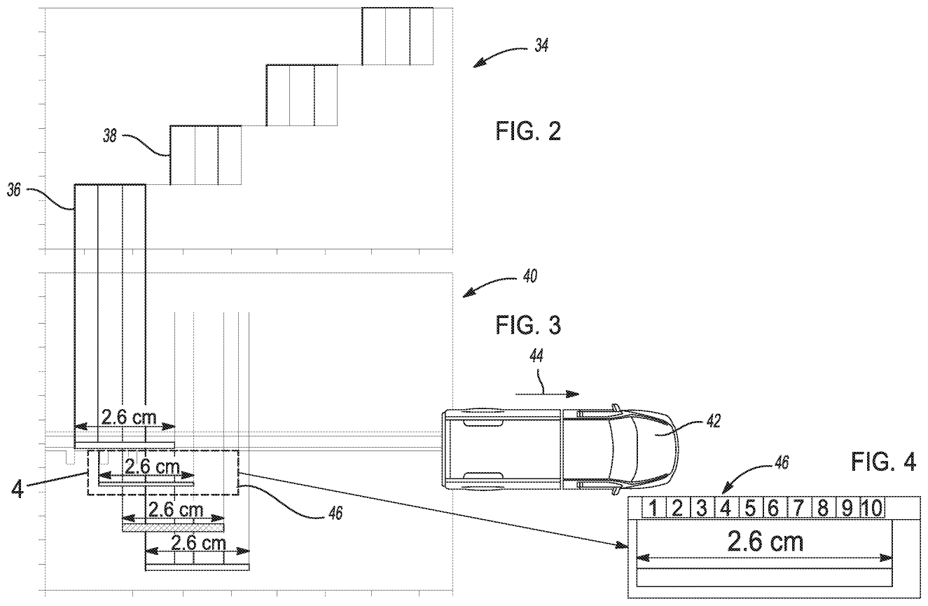

Referring to FIG. 2 and again to FIG. 1, a graph 34 provides an output from all four sensors 30 identified individually for each of the slotted wheels 26 plotted over time. As previously noted, for an exemplary period between successive signal “ticks” or counts identifying individual slotted wheel teeth, a first signal tick 36 received from the right front wheel is separated in time from a second signal tick 38 received from the right front wheel. The output from the other three wheel sensors is similar. As previously noted, based on a geometry of the slotted wheel 26 having 96 teeth and a standard wheel size of sixteen inch radius, the resolution is approximately 2.6 cm of vehicle distance traveled between each successive signal tick pair.

Referring to FIG. 3 and again to FIGS. 1 through 2, to enhance the resolution provided from the WSS of each slotted wheel, the method for producing high resolution virtual wheel speed sensor data 10 applies images received from one or more vehicle mounted cameras presented in pixels. An exemplary camera image 40 is presented for one of multiple cameras of a vehicle 42 such as a backward looking camera shown, or a forward looking camera. The camera image 40 defines a roadway, a parking lot, or similar vehicle environment. The vehicle 42 can be an automobile vehicle defining a car, a van, a pickup truck, a sport utility vehicle (SUV), or the like. The camera image 40 is modified by overlaying onto the camera image 40 multiple repetitive overlapping distance intervals representing simultaneous application of the WSS data being continuously received from all four wheels as the vehicle 42 travels in a forward direction 44. According to an exemplary aspect, the overlapping distance intervals can be 2.6 cm.

Referring to FIG. 4 and again to FIG. 3, an exemplary one of the distance intervals 46 is presented. The distance interval 46 presents how improved resolution is provided by overlapping the output from one of the slotted wheels 26 onto the camera image 40. The modified camera image 40 provides a resolution based on a predetermined quantity of pixels per image which is discretized to improve the resolution provided by the slotted wheel 26. In the example presented, the modified camera image 40 provides a resolution of approximately 10 pixels per image (shown numbered from 1 to 10) which is discretized to improve the approximate 2.6 cm resolution provided using a sixteen inch radius wheel with a slotted wheel 26 having 96 counts per revolution, to approximately 0.26 cm (approximately 3 mm). By varying the size of the wheel, the quantity of slots and therefore the quantity of counts per revolution of the slotted wheel, and the quantity of pixels of the camera image 40, the resultant resolution will vary accordingly. For example it is noted a higher resolution camera will produce a higher resolution, for example 20 pixels per cm. An optical flow program is used to discretize the image space in pixels and extrapolate the vehicle distance traveled to obtain a higher resolution vehicle displacement by pixelating the image in-between WSS ticks.

The four WSSs used concurrently can also be further enhanced by adding data from all of the camera feeds of the vehicle 42 plus other vehicle information, which can include but is not limited to a steering angle, one or more tire pressures, global positioning system (GPS) data, vehicle kinematics, and the like, which is all fused together using the algorithm discussed in reference to FIG. 9 to improve the resolution of the vehicle motion estimation and to provide a prediction capability. As noted herein, a single WSS provides a specific resolution of approximately 2.6 cm, however, increased resolution is achieved by using the outputs of all four wheel speed sensors 30 at the same time where the wheel speed sensors 30 are out of phase. After one cycle of each WSS, a next WSS tick provides an updated displacement and velocity reading. According to several aspects, all of the WSS devices are read simultaneously, therefore displacement readings are updated more frequently than sampling taken from a single WSS. In the controller 20 sampling output is averaged to account for changes in phase between WSS counts.

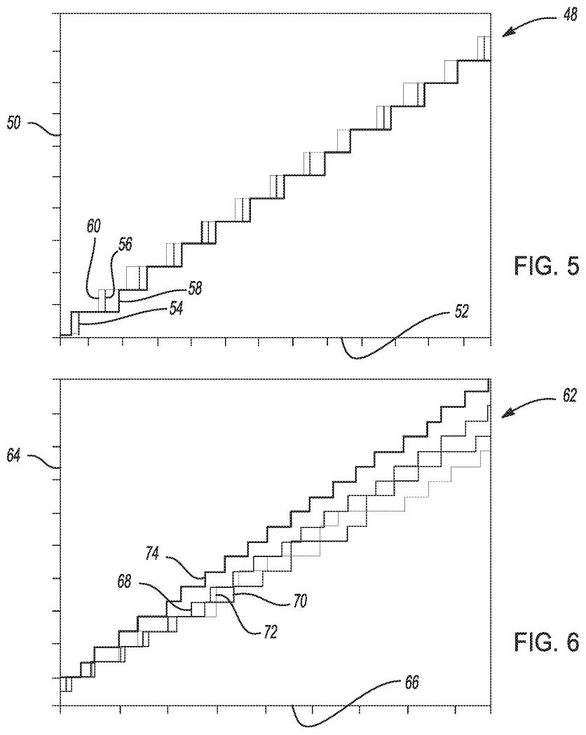

Referring to FIG. 5 and again to FIG. 2, a graph 48 presents multiple WSS wheel distance pulse counts 50 versus time 52 for a vehicle traveling in a straight path. The graph 48 identifies curves for each of the four wheels identified as the right front (RF) 54, left front (LF) 56, right rear (RR) 58, and left rear (LR) 60. From the graph 48, it is evident that even when the vehicle is traveling straight, WSS ticks many times are not evenly distributed as time progresses, which may be due to differences in wheel rotational speeds. Road irregularities, tire characteristics like pressure and wear, and other factors affect the wheel rotational speeds. The method for producing high resolution virtual wheel speed sensor data 10 of the present disclosure therefore incorporates in the algorithm an effective tire radius by incorporating tire pressure, GPS data, vehicle kinematics, and tire slip to account for different wheel rotational speeds that may occur due to tire size and tire wear.

Referring to FIG. 6 and again to FIGS. 2 and 5, a graph 62 presents multiple WSS wheel distance pulse counts 64 versus time 66 for a vehicle that is turning. The graph 62 identifies curves for each of the four wheels identified as the right front (RF) 68, left front (LF) 70, right rear (RR) 72, and left rear (LR) 74. The graph 62 identifies that while turning, the wheels turn at different speeds, therefore the WSS counts are not aligned, and will shift as time passes. The method for producing high resolution virtual wheel speed sensor data 10 of the present disclosure therefore modifies the algorithm to normalize wheel rotational speed data by scaling up or down time depending on steering wheel angle and vehicle kinematics.

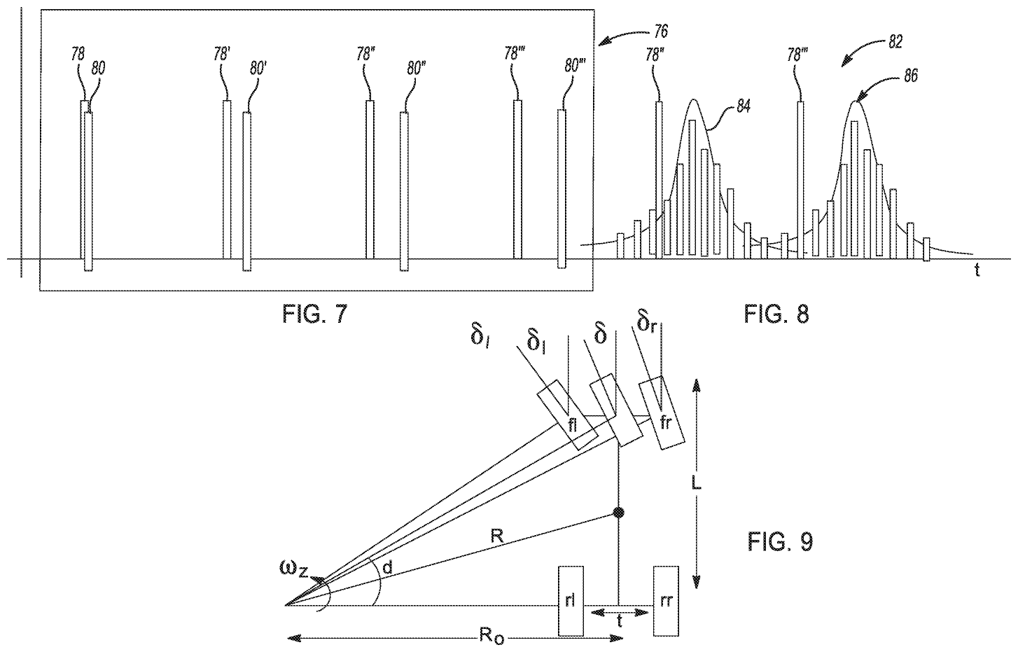

Referring to FIG. 7 and again to FIGS. 2, 5 and 6, to account for differences in tire radii and their relationship between WSSs, signals are normalized during an initial learning phase. During the learning phase data is accessed including a steering angle, a tire pressure and a tire slip. Exemplary tick frequencies over time demonstrate first tick distribution values 78, 78′, 78″, 78′″ for a first WSS compared to second tick distribution values 80, 80′, 80″, 80′″ for a second WSS.

Referring to FIG. 8 and again to FIG. 7, a graph 76 presents a probability distribution function 82 which is built for the relationship of the first tick distribution values 78, 78′, 78″, 78′″ versus the second tick distribution values 80, 80′, 80″, 80′″ presented in FIG. 7. Using the probability distribution function 82, a predicted distance traveled of a next or subsequent WSS tick 86 is provided.

Referring to FIG. 9, according to additional aspects, the Ackerman Steering Model is applied to account for wheel speed differences occurring during steering or vehicle turns at low vehicle speeds (assuming no tire slip), with Ackerman error correction applied to normalize wheel speeds using vehicle kinematics to scale up/down WSS time data. In the following equations, fl=front left wheel, fr=front right wheel, rl=rear left wheel, and rr=rear right wheel. In addition, L=vehicle wheel base, t=track length, ω=wheel speed, R=vehicle turning radius, and δ=average road wheel angle.

The different wheel speeds are obtained using the following equations: ωᵣₗrᵣₗ=ω_{z}Rᵣₗ, ωᵣᵣrᵣᵣ=ω_{z}Rᵣᵣ, ω_{fl}r_{fl}=ω_{z}R_{fl}, ω_{fr}r_{fr}=ω_{z}R_{fr}. The wheel speeds obtained from the above equations can each be normalized, for example by dividing each wheel speed by ωᵣ₁ as follows:

ωᵣₗ/ωᵣₗ; ωᵣᵣ/ωᵣₗ; ω_{fr}/ωᵣₗ; ω_{fl}/ωᵣₗ.

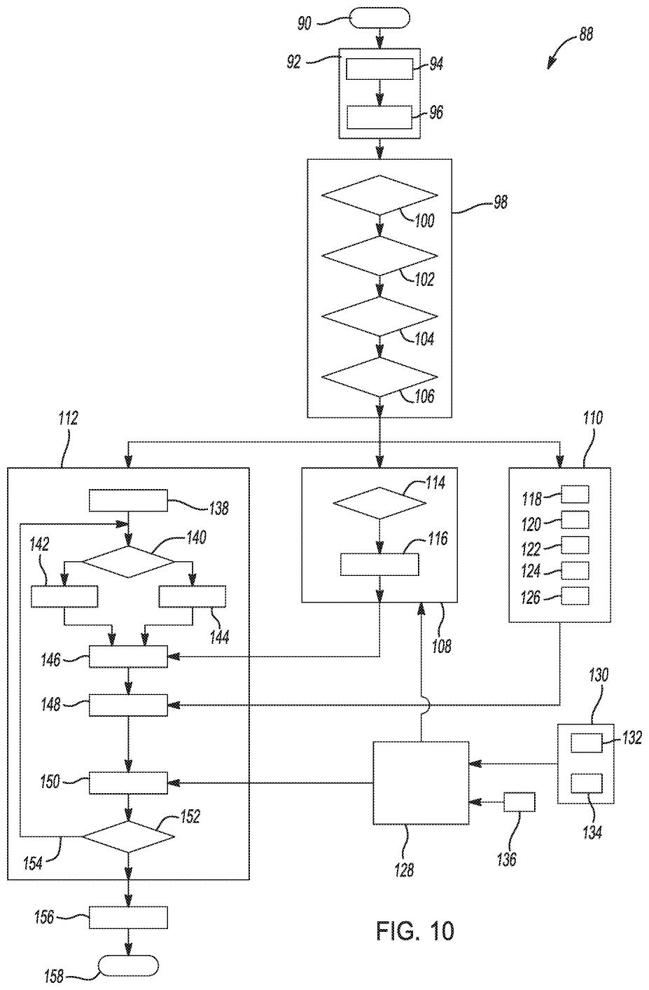

Referring to FIG. 10 and again to FIGS. 1 through 9, a flowchart identifies the method steps used in applying an algorithm 88 defining the method for producing high resolution virtual wheel speed sensor data 10 of the present disclosure. From an algorithm start 90, a learning phase 92 is initially conducted a single time wherein in a storage step 94 the WSS data for all four wheels for one revolution of all of the wheels is stored. In a second step 96, the differences in tire radii are accounted for by normalizing the WSS data.

Following the learning phase 92, in an enablement block 98 multiple enablement conditions are assessed. These include each of: a first enablement condition 100 wherein it is determined if the vehicle is on; a second enablement condition 102 wherein it is determined if the vehicle is moving slowly defined as a vehicle speed below a predetermined threshold speed; a third enablement condition 104 wherein it is determined if an absolute value of a steering wheel angle gradient is less than a predetermined threshold; and a fourth enablement condition wherein it is determined if a value of tire slip is less than a predetermined threshold. If the outcome of each of the enablement conditions is yes, the algorithm 88 initiates multiple sub-routines, including a first sub-routine 108, a second sub-routine 110 and a third sub-routine 112.

In the first sub-routine 108 WSS data is normalized for a turning vehicle by determining in a first phase 114 if a vehicle steering angle is greater than a predetermined threshold. If the output from the first phase 114 is yes, in a second phase 116 WSS time scales are normalized.

In the second sub-routine 110 an optical flow program is enabled. The optical flow program includes in a first optical flow feature 118 performing image warping to identify a birds-eye view of the roadway or vehicle environment image. In a second optical flow feature 120 corners and features are detected, for example applying the Shi-Tomasi algorithm for corner detection, to extract features and infer the contents of an image. In a third optical feature 122 an optical flow algorithm is run, for example applying the Lucas-Kanade method in an image pair. The Lucas-Kanade method is a differential method for optical flow estimation which assumes that a flow is essentially constant in a local neighborhood of a pixel under consideration, and solves the basic optical flow equations for all the pixels in that neighborhood using least squares criterion. In a fourth optical feature 124, output vectors are obtained. In a fifth optical feature 126, the output vectors are averaged and outliers are deleted to obtain a highest statistically significant optical vector that defines a vehicle distance travelled. The present disclosure is not limited to the performing optical flow using the Shi-Tomasi algorithm and the Lucas-Kanade method, as other algorithms and methods can also be applied.

In the third sub-routine 112 elements identified in each of the first sub-routine 108 and the second sub-routine 110 are applied against each output from each WSS. Following a first WSS period 138, in a triggering step 140 it is determined if any other WSS edge or tooth is triggered. If the response to the triggering step is yes, in an updating step 142 velocity and displacement values are updated using the probability distribution function 82 described in reference to FIG. 7 to account for differences in tire radii and to confirm the WSS are in-synchronization. If the response to the triggering step 140 is no, in an application step 144 previous values are applied to the image. After either the updating step 142 or the application step 144 is completed, in a normalization step 146 the WSS time scale is normalized using the output of the first sub-routine 108 if it is determined the vehicle is turning. In a discretizing step 148, an extrapolated camera image or portion is discretized, which represents a physical distance traveled by the vehicle, using the optical flow output vectors generated in the second sub-routine 110.

In parallel with the first sub-routine 108 and the second sub-routine 110, a vehicle kinematics sub-routine 128 is run using the Ackerman Steering Model described in reference to FIG. 8. One input to the vehicle kinematics sub-routine 128 is a value of effective tire radii, which are calculated using an effective tire radius determination 130. The effective tire radius determination 130 is performed using as combined inputs 132 a tire pressure, WSS values, a GPS vehicle velocity, and brake and accelerator pedal positions. An output 134 from the effective tire radius determination 130 defines a tire radius for each of the front left, front right, rear left and rear right tires. In addition to receiving the output 134 from the effective tire radius determination 130, a second input to the vehicle kinematics sub-routine 128 is a value of tire slip 136.

Returning to the third sub-routine 112, the optical flow vector output from the normalization step 146 is applied in a sensor fusion step 150 which also incorporates the wheel velocity output from the vehicle kinematics sub-routine 128. Sensor data fusion is performed using either Kalman filters (KF) or extended Kalman filters (EKF).

Following the sensor fusion step 150, in a subsequent triggering step 152 it is determined if a subsequent WSS edge is triggered. If the response to the triggering step 152 is no, in a return step 154 the algorithm 88 returns to the triggering step 140. If the response to the triggering step 152 is yes, a continuation step 156 is performed wherein the output from the third sub-routine 112 is averaged to account for changes in phases between each of the WSS counts. The algorithm 88 ends at an end or repeat step 158.

The method for producing high resolution virtual wheel speed sensor data 10 of the present disclosure offers several advantages. These include provision of an algorithm that fuses WSS data, steering and on-vehicle camera feeds, along with other vehicle information including vehicle steering, tire pressure, and vehicle kinematics to calculate a higher resolution vehicle displacement and motion and to create improved path planning algorithms. Higher resolution predictions are made of vehicle displacement at low vehicle speeds. The resolution improves from use of a single WSS only when cameras are used and fused with all 4 WSS concurrently.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for producing high resolution virtual wheel speed sensor data, comprising:
collecting wheel speed sensor (WSS) data from multiple wheels of an automobile vehicle;
generating a camera image from at least one camera mounted to the automobile vehicle;
applying an optical flow program to discretize the camera image to obtain a vehicle distance traveled in pixels from the WSS data; and
overlaying multiple distance intervals onto the output from the optical flow program.

2. The method for producing high resolution virtual wheel speed sensor data of claim 1, further including:
determining if a vehicle steering angle is greater than a predetermined threshold; and
normalizing the WSS data if the vehicle steering angle identifies the vehicle is turning.

3. The method for producing high resolution virtual wheel speed sensor data of claim 1, further including adding data from multiple camera feeds of the vehicle plus a steering angle, one or more tire pressures, global positioning system (GPS) data, and vehicle kinematics.

4. The method for producing high resolution virtual wheel speed sensor data of claim 1, further including incorporating an effective tire radius by adding a tire pressure and tire slip to account for different wheel rotational speeds occurring due to tire size and tire wear.

5. The method for producing high resolution virtual wheel speed sensor data of claim 1, further including:
identifying wheel rotational speeds from the WSS data; and
normalizing the wheel rotational speeds by scaling up or down time depending on steering wheel angle.

6. The method for producing high resolution virtual wheel speed sensor data of claim 1, further including:
during a learning phase accessing data including a steering angle, and each of a tire pressure and a tire slip for each of the multiple wheels; and
creating a probability distribution function defining a relationship between first tick distribution values of one wheel speed sensor versus second tick distribution values from the one wheel speed sensor.

7. The method for producing high resolution virtual wheel speed sensor data of claim 1, further including applying an Ackerman steering model to include wheel speed differences occurring during steering or vehicle turns at vehicle speeds below a predetermined threshold.

8. The method for producing high resolution virtual wheel speed sensor data of claim 7, further including inputting each of:
a value of an effective tire radius; and
a value of tire slip.

9. The method for producing high resolution virtual wheel speed sensor data of claim 8, wherein the effective tire radius defines a tire radius for each of a front left tire, a front right tire, a rear left tire and a rear right tire.

10. The method for producing high resolution virtual wheel speed sensor data of claim 1, further including:
enabling an optical flow program including:
in a first optical flow feature detecting corners and features of a camera image;
in a second optical feature running an optical flow algorithm;
in a third optical feature, obtaining output vectors; and
in a fourth optical feature averaging the output vectors and deleting outliers to obtain a highest statistically significant optical vector that defines a vehicle distance traveled in pixels.

11. A method for producing high resolution virtual wheel speed sensor data, comprising:
simultaneously collecting wheel speed sensor (WSS) data from multiple wheel speed sensors each sensing rotation of one of multiple wheels of an automobile vehicle;
generating a camera image of a vehicle environment from at least one camera mounted in the automobile vehicle;
overlaying multiple distance intervals onto the camera image each representing a vehicle distance traveled generated from the WSS data; and
creating a probability distribution function predicting a distance traveled for a next WSS output.

12. The method for producing high resolution virtual wheel speed sensor data of claim 11, wherein the probability distribution function defines a relationship between first tick distribution values of individual ones of the wheel speed sensors versus second tick distribution values from the same one of the wheel speed sensors.

13. The method for producing high resolution virtual wheel speed sensor data of claim 11, further including applying an optical flow program to discretize the camera image in pixels.

14. The method for producing high resolution virtual wheel speed sensor data of claim 13, further including applying a predetermined quantity of pixels per centimeter for each of the distance intervals such that the discretizing step enhances the resolution from centimeters to millimeters.

15. The method for producing high resolution virtual wheel speed sensor data of claim 11, further including identifying wheel rotational speeds from the WSS data and normalizing the wheel rotational speeds by dividing each of the wheel rotational speeds by a same one of the wheel rotational speeds.

16. The method for producing high resolution virtual wheel speed sensor data of claim 11, further including:
generating optical flow output vectors for the camera image; and
discretizing the camera image to represent a physical distance traveled by the automobile vehicle.

17. The method for producing high resolution virtual wheel speed sensor data of claim 11, further including generating the wheel speed sensor (WSS) data using slotted wheels co-rotating with each of the multiple wheels, with a sensor reading ticks as individual slots of the slotted wheels pass the sensor, the slotted wheels each having a quantity of slots defining a resolution for each of the multiple distance intervals.

18. A method for producing high resolution virtual wheel speed sensor data, comprising:
simultaneously collecting wheel speed sensor (WSS) data from each of four wheel speed sensors each individually sensing rotation of one of multiple wheels of an automobile vehicle;
generating a camera image of a vehicle environment from at least one camera mounted to the automobile vehicle;
applying an optical flow program to discretize the camera image in pixels;
overlaying multiple distance intervals onto the discretized camera image each representing a vehicle distance traveled defining a resolution of each of the multiple wheel speed sensors; and
creating a probability distribution function predicting a distance traveled for a next WSS output.

19. The method for producing high resolution virtual wheel speed sensor data of claim 18, wherein:
each wheel speed sensor determines rotation of a slotted wheel co-rotating with one of the four vehicle wheels, each slotted wheel including multiple equally spaced teeth positioned about a perimeter of the slotted wheel; and
the applying step enhances the resolution from centimeters derived from a spacing of the teeth to millimeters.

20. The method for producing high resolution virtual wheel speed sensor data of claim 18, further including:
identifying wheel speeds from the WSS data;
applying an Ackerman steering model with Ackerman error correction to include differences in the wheel speeds occurring during steering or vehicle turns at vehicle speeds below a predetermined threshold;
generating optical flow output vectors for the camera image; and
averaging the output vectors to obtain a highest statistically significant optical vector to further refine a value of the vehicle distance traveled.
